(19) United States
(12) Patent Application Publication
(10) Pub. No.: US 2015/0214816 A1
(43) Pub. Date: Jul. 30, 2015

(54) GEAR-DRIVEN GENERATOR WITH OFFSET AXIS OF ROTATION AND INTEGRATED COOLING SYSTEM

(71) Applicant: OECO, LLC, MILWAUKIE, OR (US)

(72) Inventor: Bernard Anthony Raad, West Linn, OR (US)

(73) Assignee: OECO, LLC, MILWAUKIE, OR (US)

(21) Appl. No.: 14/581,120

(22) Filed: Dec. 23, 2014

Related U.S. Application Data
(60) Provisional application No. 61/920,204, filed on Dec. 23, 2013.

(51) Int. Cl. H02K 9/19; H02K 7/116

(52) U.S. Cl. CPC H02K 9/19; H02K 7/116

(57) ABSTRACT

An electrical generator and drive shaft assembly are disclosed. The electrical generator may include a step-up gearbox to minimize the required volume and weight of the generator for onboard aircraft electricity generation. The electrical generator and drive shaft interface may be axially offset. The electrical generator may also include a self-contained fluid cooling and lubrication system that may employ on-board fuel to absorb generated heat and/or oil to lubricate and cool generator components.

### CROSS REFERENCE TO RELATED APPLICATIONS

This application relates to, and claims the benefit of the earlier filing date and priority of U.S. Provisional Patent Application No. 61/920,204, filed on Dec. 23, 2013, entitled “Gear-Driven Generator with Offset Axis of Rotation and Integrated Cooling System.”

### FIELD OF THE INVENTION

The present invention relates to electrical generators and systems and methods for cooling electrical generators.

### BACKGROUND

Electrical generators, including geared generators, have existed for a while and have been developed for a variety of conditions and applications. One application for which electrical generators are needed is to provide on-board electrical power for vehicles, such as aircraft, although the invention should not be limited to these applications. It is appreciated that the generation of electrical power on an aircraft can present unique weight and size limitation challenges for the generator designer.

For example, a typical aircraft engine for which the various generator embodiments disclosed herein may need to be compatible, may have a relatively low speed (˜4000 RPM) power take-off pad available to drive the electrical generator. Absent one or more of the advantageous design features of the generator embodiments of the present invention, this relatively low speed of rotation would result in the need for an intolerably large and heavy generator to produce the required amount of electrical energy. Additionally, the pad may have limited space around it in which to locate the generator. Still further, the ability to provide the required level of cooling in the pad area may be impaired because the air flow is unpredictable.

While some known electrical generators have been fluid cooled to address some of the foregoing challenges, none include all the features of the various generator embodiments described herein. Furthermore, none of the known electrical generators include the features of the various generator embodiments described herein in combination with the innovative self-contained fuel/oil heat exchanger used to cool the various generator embodiments described.

### BRIEF DESCRIPTION OF THE DRAWINGS

In order to assist the understanding of this invention, reference will now be made to the appended drawing, in which like reference numerals refer to like elements. The drawing is exemplary only, and should not be construed as limiting the invention.

FIG. 1 is an isometric outline view of an electrical generator and drive shaft assembly in accordance with an embodiment of the present invention.

FIG. 2 is a cross sectional view of the drive shaft assembly in accordance with the embodiment of the invention shown in FIG. 1.

FIG. 3 is a cross sectional view of the electrical generator in accordance with the embodiment of the invention shown in FIGS. 1-2.

FIG. 4 is a side cross sectional view of the drive shaft assembly and electrical generator in accordance with the embodiment of the invention shown in FIGS. 1-3.

FIG. 5 is a compound cross sectional view of the drive shaft assembly and electrical generator in accordance with the embodiment of the invention shown in FIGS. 1-4.

FIG. 6 is a detailed cross sectional view of the drive pad and input drive shaft interface in accordance with the embodiment of the invention shown in FIGS. 1-5.

FIG. 7 is a detailed cross sectional view of the drive shaft and electrical generator interface in accordance with the embodiment of the invention shown in FIGS. 1-6.

FIG. 8 is a detailed cross sectional view of the electrical generator in accordance with the embodiment of the invention shown in FIGS. 1-7.

FIG. 9 is a detailed cross sectional view of the coolant fluid input and output ports for the electrical generator in accordance with the embodiment of the invention shown in FIGS. 1-8.

FIG. 10 is a detailed cross sectional view of the coolant passages for the electrical generator in accordance with the embodiment of the invention shown in FIGS. 1-9.

FIG. 11 is a schematic diagram of the electrical generator heat exchanger components in accordance with an embodiment of the invention.

### SUMMARY OF THE INVENTION

Embodiments of the present invention comprise an electrical generator that may include a self-contained step-up gearbox to minimize the required volume and weight of the generator electromagnetics by permitting increased rotational speed of the generator. Furthermore, embodiments of the disclosed electrical generators may include a spur gear mesh assembly and mating drive shaft assembly that permit an offset axis of rotation of the drive shaft relative to the axis of rotation of the electrical generator rotor. Such configuration may take advantage of available space “off center” which may allow the main body of the electrical generator to occupy available non-co-axial space near the engine which powers the drive shaft. Further, embodiments of the present the electrical generator may include a self-contained fluid cooling and lubrication system that may employ on-board fuel to absorb generated heat and/or oil to lubricate and cool generator components.

### DETAILED DESCRIPTION OF PREFERRED EMBODIMENTS OF THE INVENTION

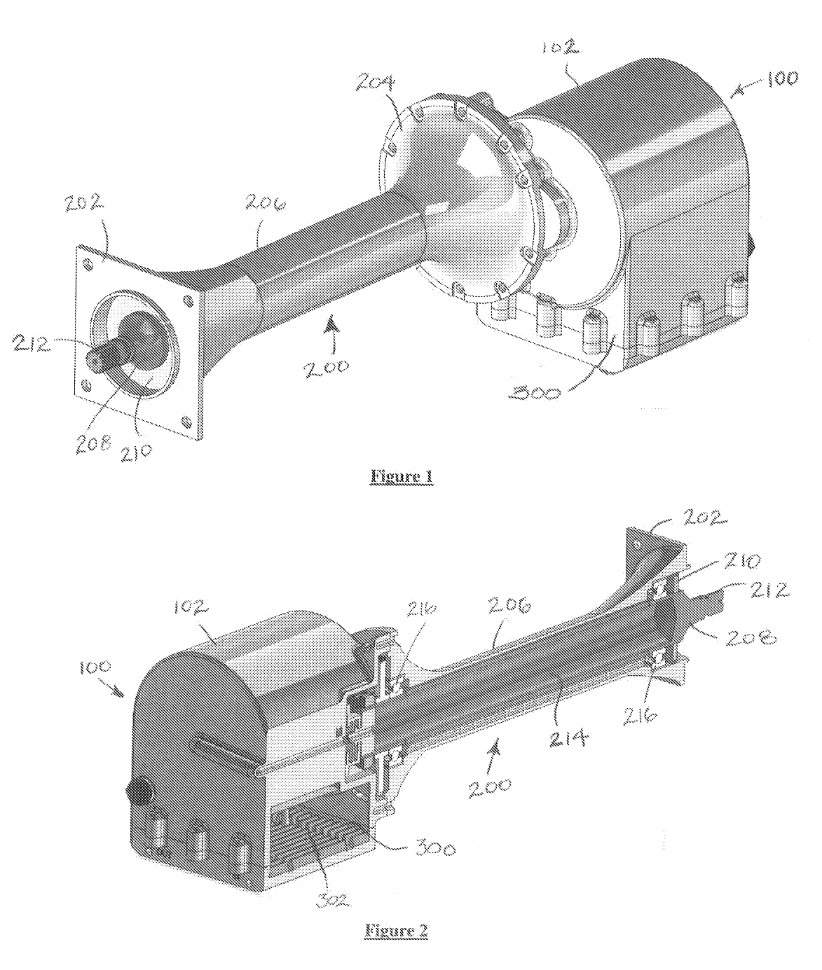

Reference will now be made in detail to a preferred embodiment of the present invention, an example of which is illustrated in the accompanying drawings. With reference to FIGS. 1 and 2, a relatively a high speed electrical generator assembly 100 may be driven by a comparatively low speed drive shaft assembly 200 and optionally cooled and lubricated with a built-in heat exchanger assembly 300. The heat exchanger assembly 300 may absorb and transfer waste heat generated by the electrical generator assembly 100 to a cooling area (not shown) with circulating fuel or some other fluid or medium.

The electrical generator assembly 100 may include a generator housing 102 in which the generator assembly components are sealed. The heat exchanger assembly 300 may include a hollow reservoir 302 for the receipt of coolant or oil.

The drive shaft assembly 200 may have a first end at which a drive pad interface 202 is provided and a second end having a generator interface housing 204 proximal to the generator assembly 100. The drive pad interface 202 may be designed to mate with any available drive pad. For example, the drive pad interface 202 may employ a square bolt pattern to mate with an onboard drive pad. The drive shaft assembly may further include a drive shaft sheath 206 which receives an input drive shaft 208. The drive shaft 208 may include a gear-toothed end 212 for receiving rotational input motion and a hollow interior 214 extending longitudinally along the length of the drive shaft. The drive shaft 208 may be supported at its two longitudinal ends by drive shaft bearing assemblies 216 and 218. A rotating seal 210 may be provided between the drive shaft sheath 206 and the drive shaft 208 to seal the space between the drive shaft and the drive shaft sheath from the ambient.

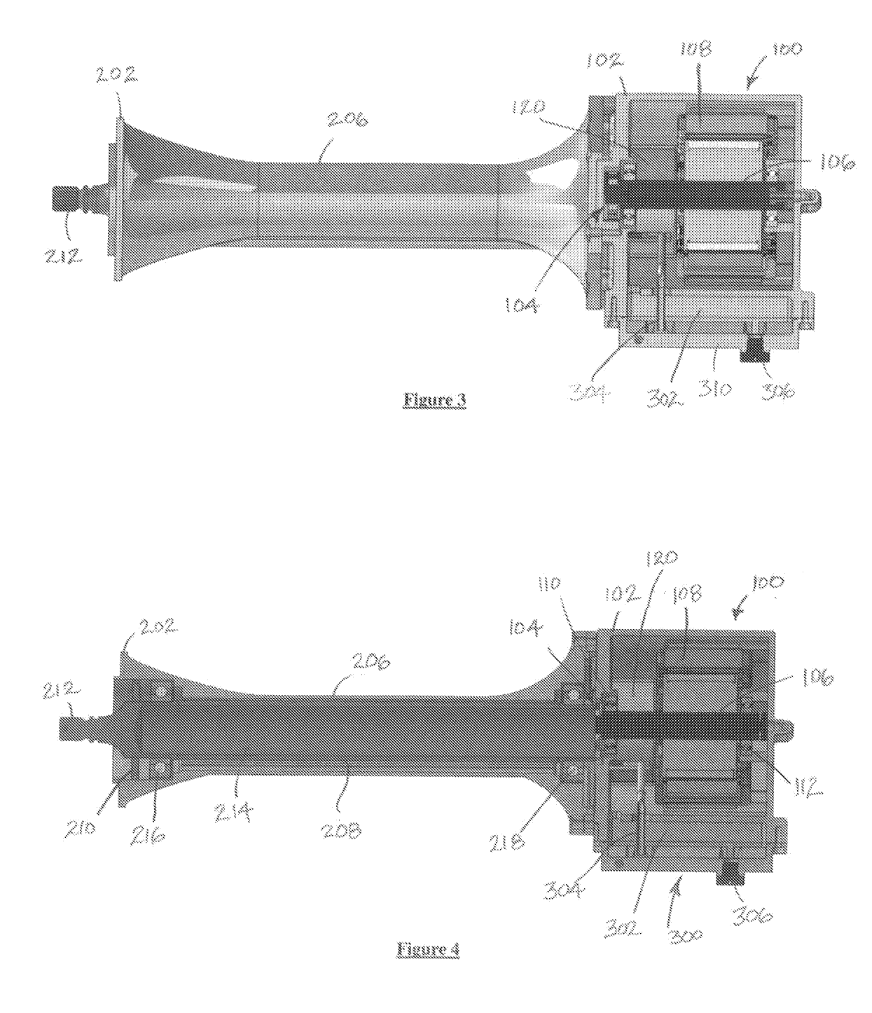

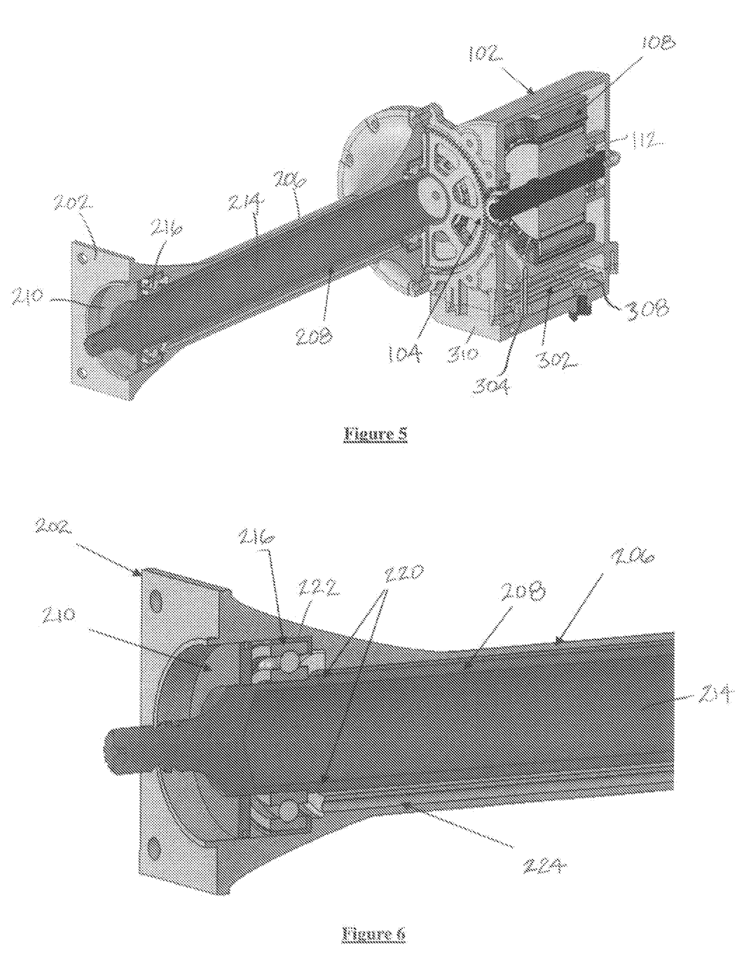

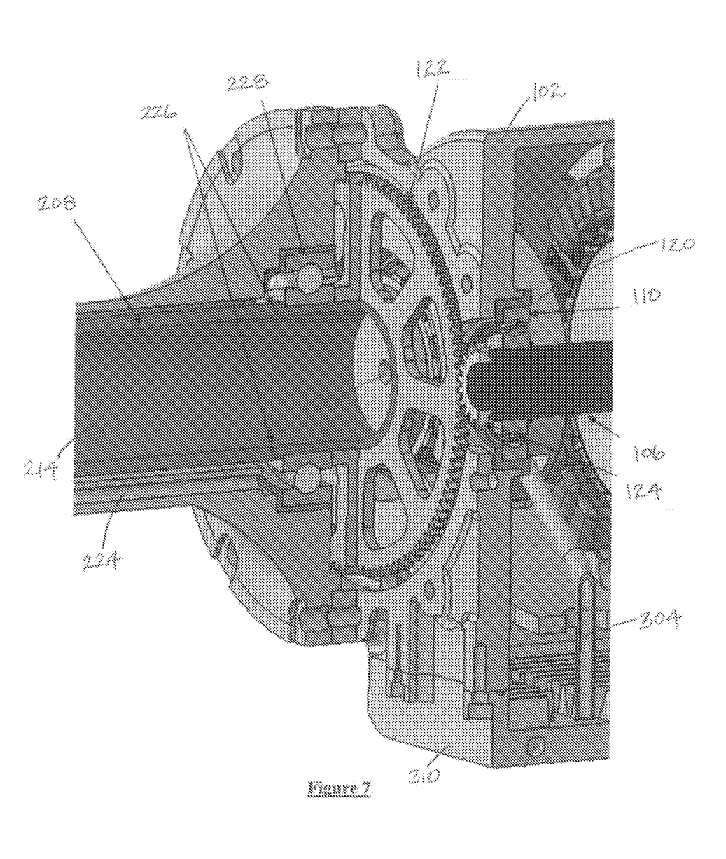

With reference to FIGS. 3, 4 and 5, the generator assembly 100 may include a set of one or more spur gear(s) 104, which may or may not incorporate an idler gear (not shown), to adequately offset the generator housing 102 from the drive shaft 206. The relatively high rotational speed of a generator shaft 106 may be achieved as a result of use of the set of spur gears, which rotationally link the input drive shaft 208 to the generator shaft. The offset arrangement of the generator assembly 100 relative to the drive shaft assembly 200 may be required so that the generator assembly is located in available space in the engine compartment, which space may not be in line with the axis of rotation of the drive pad interface 202 and drive shaft 206. The generator shaft 106 may have first and second ends supported by generator bearing assemblies 110 and 112, respectively. Electricity generating components 108, as well as a pump 120, may be disposed circumferentially about the generator shaft 106 along its length. Rotational movement of the generator shaft 106 drives the electricity generating components 108 and the pump 120.

The heat exchanger assembly 300 may have a heat exchanger housing 310 bolted on to the generator housing 102. A fluid passage 304 may extend from the reservoir 302 of the heat exchanger assembly 300 to the pump 120 in the generator assembly 100. A plurality of heat exchanging fins 308 may extend into the reservoir 302 from the heat exchanger housing 310. A fill/drain plug 306 may be provided to permit fluid, such as coolant or oil, to be provided to and drained from the reservoir 302.

With reference to FIG. 6, which illustrates details of the drive pad end of the drive shaft assembly 200, one or more orifices or fluid passages 220 may extend from the hollow interior 214 through the wall of the drive shaft 208 to the space in which the drive shaft bearing assembly 216 resides. These orifices 220 may be used to conduct lubricating oil onto the bearing assembly 216 and seal 210 from the pump 120. The fluid, such as oil, delivered to the bearing assembly 216 may collect in fluid passage 222, which in turn communicates with a fluid return passage 224 provided in the drive shaft sheath 206. Fluid returned to the generator assembly end of the return passage 224 may be delivered to the interior of the generator housing 102 from which it can drain to the heat exchanger assembly 300.

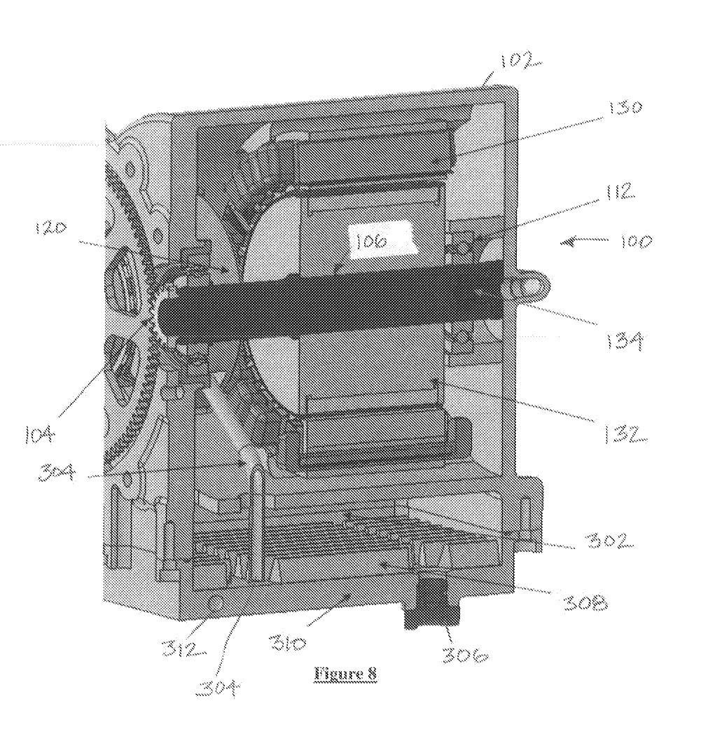

With reference to FIG. 7, which illustrates details of the generator assembly end of the drive shaft assembly 200, a port 126 may provide fluid communication between an outlet of the pump 120 and the hollow interior 214 of the drive shaft 208. Lubricating and cooling fluid may be pumped from the pump 120 through the port 126 to the drive shaft 208. The fluid pump 120 may be driven by either the low speed drive shaft 106, as shown, or alternatively, by the higher speed generator shaft 206. One or more orifices or fluid passages 226 may extend from the hollow interior 214 through the wall of the drive shaft 208 to the space in which the drive shaft bearing assembly 218 resides. These orifices 226 may be used to conduct lubricating oil onto the bearing assembly 218 from the pump 120. The fluid, such as oil, delivered to the bearing assembly 218 may collect in fluid passage 228, which in turn communicates with the interior of the generator housing 102. Fluid returned to the interior of the generator housing 102 may drain to the heat exchanger assembly 300.

With continued reference to FIG. 7, the input drive shaft 206 may be attached to an input gear 122. The drive shaft 206 gear assembly including input gear 122 may drive a pinion gear 124 which is co-axial with and fixed to the generator shaft 106, but axially offset from the drive shaft 206 to take advantage of space limitations. Because of the ratio of their respective teeth, the drive shaft 206 may rotate the generator shaft 106 to which the pinion gear 124 is attached, at an increased speed. The gearing ratio of the input gear 122 to the pinion gear 124 may be selected as is necessary and desirable to reduce the weight and volume of the electric generator assembly 100 electricity generating components 108. For example, a ratio of rotation of the input gear to pinion gear may be in the range of 1:4 or greater.

With reference to FIG. 8, the generator assembly 100 electricity generating components may include a permanent magnet rotor 132 and a stator 130 though it should be understood that in an alternative embodiment of the invention, the electricity generating components may comprise a wound field three-in-one generator or any brushless motor—for example used to apply motive force to start a gas turbine or other type engine through drive shaft assembly 200.

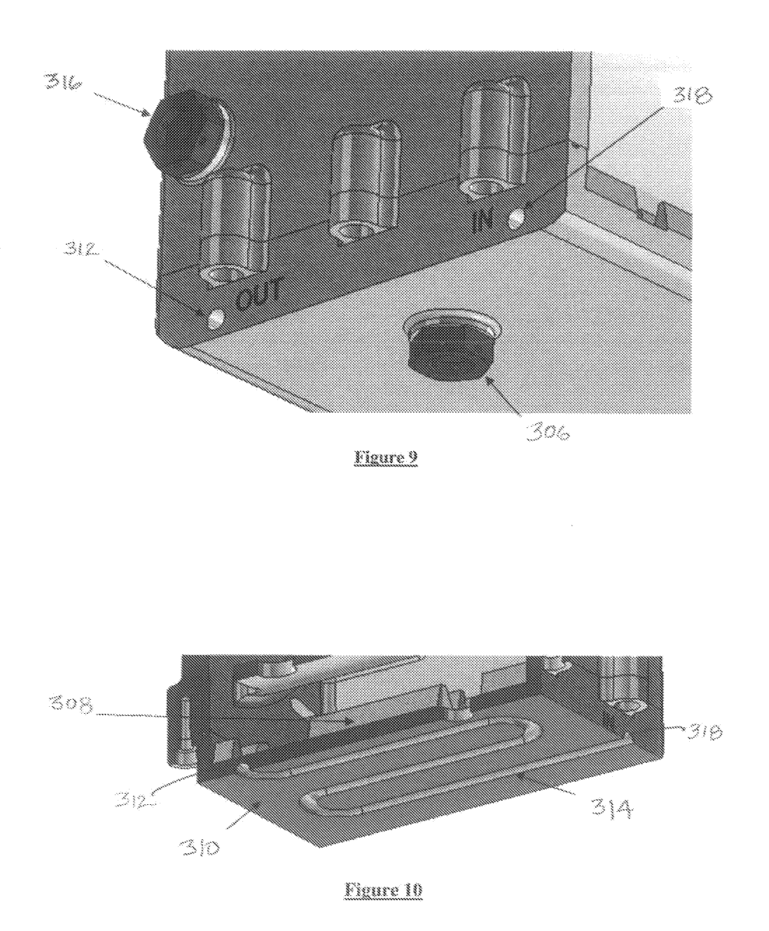

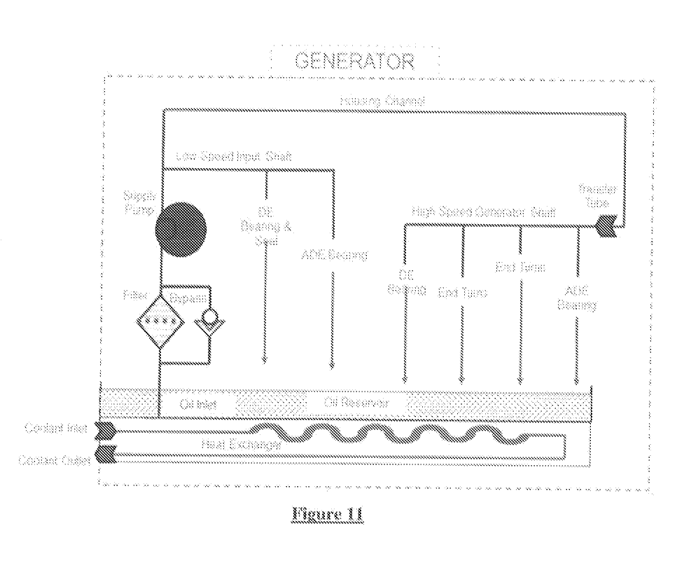

With continued reference to FIG. 8 and additional reference to FIGS. 9 and 10, the built-in heat exchanger assembly 300 collects sprayed coolant, such as fuel or oil, to cool the generator assembly 100 and drive shaft assembly 200 by circulating the lubricating and/or coolant fluid within passages formed their respective housings. The fluid contained within the heat exchanger assembly 300 may be drawn by the pump 120 through the fluid passage 304 from the reservoir 302. The fluid passage or tube 304 may draw coolant from the bottom of the reservoir 302 after it has been de-aerated, and may deliver it to the pump elements (not shown). The coolant may be pumped from the anti-driven end (ADE) of the drive shaft 206 to the generator shaft 106 by means of a transfer tube 134. Coolant spray orifices may be strategically located in the generator shaft 106 wall to provide adequate cooling and lubrication for sensitive generator components.

Fluid returned to the heat exchanger assembly 300 may come into contact with heat exchanging fins 308 located in the base of the heat exchanger housing 310 of the heat exchanger. FIG. 9 shows an inlet port 318 and an outlet port 312 for the available coolant fluid such as fuel or hydraulic fluid. Also shown are a fill plug 316 and a drain plug 306 for the internally contained and circulating coolant of the heat exchanger assembly 300. FIG. 10 shows a preformed stainless steel tube 314 which may be cast into an aluminum base of the heat exchanger housing 310. This configuration is made possible because the casting temperature of aluminum is much lower than the melting point of stainless steel.

FIG. 11 is a schematic illustration of an example of the coolant flow path for the electric generator described above. In the example illustrated in FIG. 11, the coolant is referred to as oil, the anti-driven end of a component is referred to as “ADE,” and the driven end of a component is referred to as “DE.” With regard to FIG. 11, it is apparent that in a preferred embodiment, oil coolant may be drawn through an oil inlet from an oil reservoir by a supply pump. The oil may pass through a de-aeration filter and/or a bypass valve. The supply pump may pump the oil through housing channels (i.e., fluid passages), the drive shaft hollow interior, and the generator shaft hollow interior, to the driven ends and anti-driven ends of the drive shaft bearing assemblies and the generator bearing assemblies, as described above. The supply pump may also pump cooling oil to the end turns of the electricity generating components. The cooling oil may be returned from the generator housing to the oil reservoir and the heat stored in the oil may be transferred away by coolant that is passed through the heat exchanger housing.

It will be apparent to those skilled in the art that variations and modifications of the present invention can be made without departing from the scope or spirit of the invention. For example, the scope of the invention includes electric generators which are considered wound-field and are controllable, such those that use a regulator to control output voltage. In another example, the electric generator may be a brushless, self-excited device featuring a three-in-one arrangement with an exciter generator and an auxiliary PMG. In yet another example, external cooling fins could be added to the generator housing to radiate away some of the heat generated by the frictional forces of the electric generator. Still further, such fins could be cooled by natural or forced air flow. In yet another alternative embodiment, an idler gear could be positioned between the large input gear and the small pinion gear to further offset the centerlines of the drive shaft and generator shaft appropriately and locate the body of the generator into available space. It is intended that the present invention cover all such modifications and variations of the invention, provided they come within the scope of the appended claims and their equivalents.

What is claimed is:

1. A system for generating electrical power, said system comprising:
a generator assembly having:
a generator housing;
a generator shaft having first and second ends;
electricity generating components disposed about the generator shaft;
a generator shaft bearing provided at each of the generator shaft first and second ends;
a pinion gear provided on said generator shaft;
a fluid pump disposed within the generator housing, said fluid pump having an inlet port and an outlet port; and
one or more fluid passages extending from the fluid pump outlet port to each generator shaft bearing;
a drive shaft assembly having:
a drive shaft sheath;
a drive shaft disposed within the drive shaft and having first and second ends, said drive shaft second end being proximal to the generator shaft first end;
a drive shaft bearing provided at each of the drive shaft first and second ends; and
an input gear provided at the drive shaft second end, said input gear operationally engaged with said pinion gear and having a ratio of rotation with said pinion gear of 1:4 or greater; and
a heat exchanger assembly disposed adjacent to said generator housing, said heat exchanger assembly having:
a heat exchanger housing;
a fluid passage extending through the heat exchanger housing;
a fluid chamber disposed within the heat exchanger housing adjacent to the fluid passage extending through the heat exchanger housing; and
a fluid passage extending from the fluid chamber to the fluid pump inlet port.

2. The system of claim 1, wherein the generator shaft and the drive shaft each have longitudinal axis which are offset relative to each other.

3. The system of claim 2, further comprising:
one or more fluid passages extending from the fluid pump to the drive shaft bearing at the drive shaft first or second end.

4. The system of claim 2, further comprising:
a central fluid passage extending through the drive shaft from the drive shaft second end to the drive shaft first end;
a fluid passage extending from the fluid pump to the drive shaft central fluid passage; and
one or more fluid passages extending from the drive shaft central fluid passage to the drive shaft bearings at the drive shaft first and second ends.

5. The system of claim 4, further comprising:
a fluid return passage provided in the drive shaft sheath, said fluid return passage extending from the drive shaft first end to the drive shaft second end.

6. The system of claim 5, further comprising:
an inner fluid passage extending through the generator shaft from the generator shaft second end to the generator shaft first end;
one or more fluid passages extending between the generator shaft inner fluid passage and the generator shaft bearings at the generator shaft first and second ends; and
one or more fluid orifices extending from the generator shaft inner fluid passage through the generator shaft to an interior of the generator housing.

7. The system of claim 1, further comprising:
a central fluid passage extending through the drive shaft from the drive shaft second end to the drive shaft first end;
a fluid passage extending from the fluid pump to the drive shaft central fluid passage; and
one or more fluid passages extending from the drive shaft central fluid passage to the drive shaft bearings at the drive shaft first and second ends.

8. The system of claim 7, further comprising:
a fluid return passage provided between the drive shaft sheath and the drive shaft, said fluid return passage extending from the drive shaft first end to the drive shaft second end.

9. The system of claim 8, further comprising:
an inner fluid passage extending through the generator shaft from the generator shaft second end to the generator shaft first end;
one or more fluid passages extending between the generator shaft inner fluid passage and the generator shaft bearings at the generator shaft first and second ends; and
one or more fluid orifices extending from the generator shaft inner fluid passage through the generator shaft to an interior of the generator housing.

10. The system of claim 1, further comprising:
an inner fluid passage extending through the generator shaft from the generator shaft second end to the generator shaft first end;
one or more fluid passages extending between the generator shaft inner fluid passage and the generator shaft bearings at the generator shaft first and second ends; and
one or more fluid orifices extending from the generator shaft inner fluid passage through the generator shaft to an interior of the generator housing.

11. The system of claim 1, further comprising:
a central fluid passage extending through the drive shaft from the drive shaft second end to the drive shaft first end;
a fluid passage extending from the fluid pump to the drive shaft central fluid passage; and
one or more fluid passages extending from the drive shaft central fluid passage to a drive shaft bearing at the drive shaft first end or drive shaft second end.

12. The system of claim 1, wherein the fluid passage extending through the heat exchanger housing is defined by a stainless steel tube.

13. The system of claim 1, wherein the drive shaft provides rotational motion to drive the fluid pump.

14. The system of claim 1, wherein the generator shaft provides rotational motion to drive the fluid pump.

15. A system for generating onboard electrical power for an aircraft, said system comprising:
a generator assembly having:
a generator housing;
a generator shaft provided with a pinion gear;
a fluid pump disposed within the generator housing; and
one or more fluid passages extending from the fluid pump to the generator shaft;
a drive shaft assembly having:
a drive shaft sheath;
a drive shaft disposed within the drive shaft sheath and provided with an input gear;
one or more fluid passages extending from the fluid pump to the drive shaft; and
a heat exchanger assembly disposed adjacent to said generator housing, said heat exchanger assembly having:
a heat exchanger housing;
a fluid chamber defined by the heat exchanger housing; and
a fluid passage extending from the fluid chamber to the fluid pump.

16. The system of claim 15, wherein said input gear operationally engages said pinion gear and a ratio of rotation of said input gear with said pinion gear is sufficient to drive the generator assembly at a rate of speed required to generate on-board power for an aircraft during take-off.

17. The system of claim 15, wherein the generator shaft and the drive shaft each have longitudinal axis which are offset relative to each other.

18. The system of claim 15, further comprising:
one or more drive shaft bearings disposed about the drive shaft; and
one or more fluid passages extending from the fluid pump to the drive shaft bearings.

19. The system of claim 18, further comprising:
a fluid return passage provided in the drive shaft sheath.

20. The system of claim 19, further comprising:
one or more generator shaft bearings disposed about the generator shaft; and
one or more fluid passages extending from the fluid pump to the generator shaft bearings.

21. The system of claim 15, further comprising:
one or more generator shaft bearings disposed about the generator shaft; and
one or more fluid passages extending from the fluid pump to the generator shaft bearings.

22. The system of claim 15, wherein the drive shaft provides rotational motion to drive the fluid pump.

23. The system of claim 15, wherein the generator shaft provides rotational motion to drive the fluid pump.
